(19) United States
(12) Patent Application Publication
(10) Pub. No.: US 2015/0100451 A1
(43) Pub. Date: Apr. 9, 2015

(54) METHOD AND SYSTEM FOR PROMOTING ONLINE SALES OF FASHION LOOKS AND ITEMS ASSOCIATED THEREWITH

(71) Applicant: DailyLook, Inc., Los Angeles, CA (US)

(72) Inventor: Brian Ree, Los Angeles, CA (US)

(21) Appl. No.: 14/046,757

(22) Filed: Oct. 4, 2013

(51) Int. Cl. G06Q 30/06

(52) U.S. Cl. CPC G06Q 30/0621
USPC 705/26.5

(57) ABSTRACT

Techniques are disclosed for promoting online sales of fashion looks and items associated therewith. In some embodiments, a method includes, upon receiving a selection of an item from a user, displaying a second look in addition to a first look. The first and second looks respectively include the item, and each look has a set of components. The method further comprises receiving a selection of one of the looks from the user. The method further comprises displaying a corresponding set of components in response to which look the user selects. Among other benefits, the embodiments disclosed herein provide a way that is more natural and convenient to customer users in the effort of promoting fashion looks and the associated items included in a respective look, thereby facilitating a better user experience, inspiring customers' imagination, and stimulating more sales.

### TECHNICAL FIELD

The present invention generally relates to systems and methods for electronic commerce, and specifically to promoting online transactions of apparel and other goods.

### BACKGROUND

Electronic commerce (“e-commerce”) has become an increasingly popular means of buying and selling commercial products such as apparel or fashion clothing. The pervasiveness of modern computer networks (e.g., the Internet) allows easy access for a customer user to browse for, compare, and purchase different products from one or more merchants at a time and location of the user's own preference. In the field of clothing sales, many retailers host websites having a home or directory page, which has links that allow the user to enter an individual page for a particular product. It is also typical for the retailers to categorize products into groups and/or subgroups by their particular audiences (e.g., men or women, tall or petite, etc.), by their types (e.g., shirts, polo shirts, outerwear, pants, shoes, bags, accessories, etc.), or perhaps by their designers.

However, conventional websites lack an efficient way to promote the sales of entire designers' looks which include multiple completing components. Also, conventional websites would require the customer user to leave his or her currently browsing page and enter a separate page in order to purchase each individual product that the customer desires . This repetitive entering and exiting from one page to another consumes extra time and effort, thereby negatively affecting the customer user's shopping experience.

### BRIEF DESCRIPTION OF DRAWINGS

The present embodiments are illustrated by way of example and are not intended to be limited by the figures of the accompanying drawings. In the drawings:

FIG. 1 illustrates a representative computer network environment within which some embodiments may be implemented;

FIG. 2 illustrates an abstract functional block diagram further explaining certain components and functionalities thereof in the server of FIG. 1 in accordance with some embodiments;

FIGS. 3A-3D respectively illustrate a user interface which can be generated by the server of FIG. 1 for facilitating online commercial transactions of fashion looks in accordance with some embodiments;

FIG. 4 illustrates a method for promoting sales of fashion looks and items associated therewith in accordance with some embodiments;

FIG. 5 illustrates additional details that can be implemented with the method of FIG. 4 in accordance with some embodiments; and

FIG. 6 illustrates a diagrammatic representation of a machine in the example form of a computer system within which a set of instructions, for causing the machine to perform any one or more of the methodologies discussed herein, can be executed.

The same reference numbers and any acronyms identify elements or acts with the same or similar structure or functionality throughout the drawings and specification for ease of understanding and convenience.

### DETAILED DESCRIPTION

Techniques are disclosed for promoting online sales of fashion looks and items associated therewith. In some embodiments, a method includes, upon receiving a selection of an item from a user, displaying a second look in addition to a first look. The first and second looks respectively include the item, and each look has a set of components. The method further comprises receiving a selection of one of the looks from the user. The method further comprises displaying a corresponding set of components in response to which look the user selects. In some embodiments, the displayed set of components are replaced with another corresponding set of components when the user selects another look.

Among other benefits, the embodiments disclosed herein provide a way that is more natural and convenient to customer users in the effort of promoting fashion looks and the associated items included in a respective look, thereby facilitating a better user experience, inspiring customers' imagination, and stimulating more sales.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known methods, procedures, structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

As used herein, a “module,” “a manager,” an “interface,” a “platform,” or an “engine” includes a general purpose, dedicated or shared processor and, typically, firmware or software modules that are executed by the processor. Depending upon implementation-specific or other considerations, the module, manager, interface, platform, or engine can be centralized or its functionality distributed. The module, manager, interface, platform, or engine can include general or special purpose hardware, firmware, or software embodied in a computer-readable (storage) medium for execution by the processor. As used herein, a computer-readable medium or computer-readable storage medium is intended to include all media that are statutory (e.g., in the United States, under 35 U.S.C. §101), and to specifically exclude all media that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

As previously mentioned, because most merchants operate based on a catalog merchandise model which focuses on the sales of individual items, typical e-commerce websites require the customer user to navigate from one product page to another in order to browse, compare and purchase each individual product item. This navigation through the webpages consumes extra time and effort, thereby negatively affecting the customer user's shopping experience, and it is particular the case in the apparel and fashion market. A conventional retailer in such field has separate categories (e.g., tops, bottoms, shoes, bags, accessories, etc.) for each individual product item, and generally the retailer hosts one or more categorical pages (e.g., under a main homepage) to list out items (or products) that belong to a particular category. Therefore, a commonly seen attempt to alleviate the aforementioned problems is the so-called “quick view” model. The quick view model may allow the customer to click on one categorical page and open, for example, a “pop-up” page to view, select attributes, and add to cart of an individual item. Indeed, many retailers have adopted this technique to allow the customers to quickly view an individual item without leaving the page that he or she is currently browsing; however, this technique is perhaps best suitable when the retailer focuses on selling and merchandising individual products, or when the customer is merely looking for purchasing an individual item.

Instead of individual products, there is an emerging market in the fashion industry which aims to sell an entire curated “look” that is created professionally by a fashion designer. A designer “look” or a fashion “look” generally includes one or more items (or components) from multiple categories. For example, a look may have many components including, for example, a top, a bottom, a pair of shoes, a bag, and accessories, and each component of the look is predetermined by the designer so that the look is generally more complete and fashionable than a layman customer's selection.

Typically, such merchants in this emerging market would simply create a “looks” or “lookbook” category under the main homepage, and when the customer selects a look, the resulting page would show items from the selected look on the same web page, but the items shown on the resulting page are merely product links which link to another page for the shown item on the merchant's website.

Whether it is a conventional webpage or the above-discussed “quick view” page, current techniques do not adequately address the need of suggesting different looks to inspire the customer user when the user shows interests in a product item, so as to promote the sales of the entire look and those items included in or associated with whatever look in which the customer user might be interested.

Accordingly, the embodiments disclosed herein provide improved techniques to enhance a user's online shopping experience by inspiring the user with different curated looks (e.g., when the user expresses interest in an item), which can in turn promote the sales of other components associated with the looks.

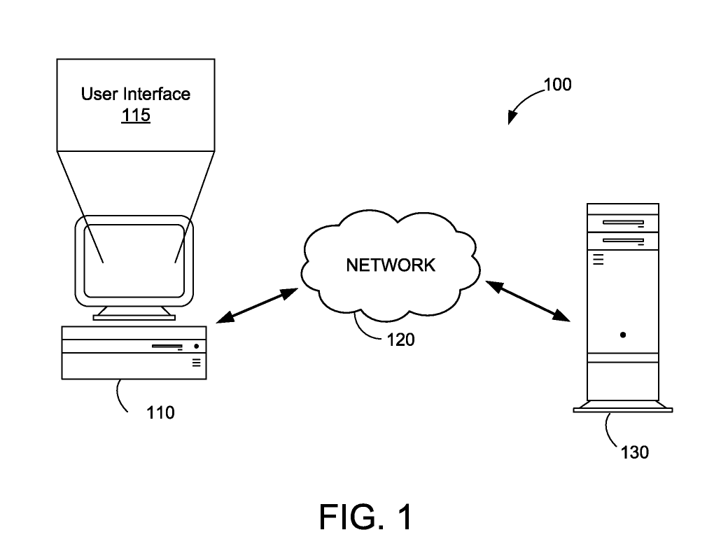

FIG. 1 illustrates a representative computer network environment 100 within which some embodiments may be implemented. The environment 100 includes a client 110, a network 120, and a server 130. The client 110 and server 130 are coupled in communication for data transmission over the network 120. For example, the components may be connected via a twisted pair cabling network, a coax cable network, a telephone network, or any suitable type of connection network. In some embodiments, the network 120 may be wireless (e.g., which may include an IEEE 802.11 wireless network, or a data traffic network based on wireless telephony services such as 3G, 3.5G, 4G LTE and the like). The technologies supporting the communications between the client 110 and server 130 may include Ethernet (e.g., as described in IEEE 802.3 family of standards) and/or other suitable types of area network technologies. One of ordinary skill in the art will understand that the components of FIG. 1 are just one implementation of the computer network environment within which present embodiments may be implemented, and the various alternative embodiments are within the scope of the present embodiments. For example, the network 120 may include intervening devices (e.g., switches, routers, hubs, etc.) in the network 120. In some examples, the network 120 comprises the Internet.

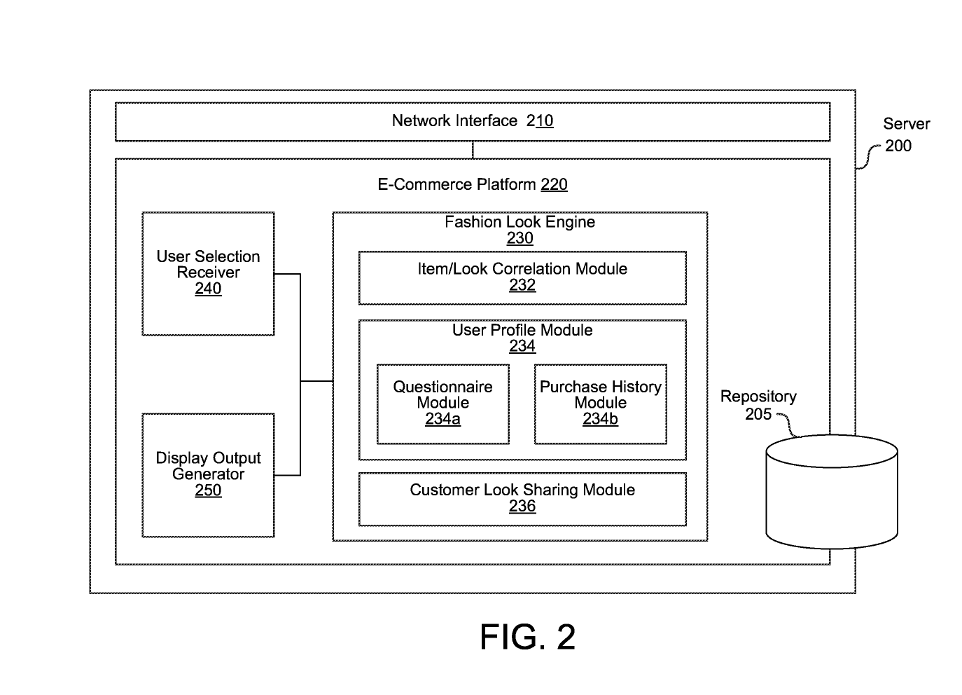

The server 130 may be one or more server computers or work stations that are employed by a merchant for hosting websites that function as a channel to customer users for browsing products and placing purchase orders. The server 130 typically includes at least one processor and a memory, and may be further connected to one or more computers (not shown in FIG. 1 for simplicity) that manage inventory, logistics and/or other commercial functions via the network 120. The server 130 is also typically equipped with or is coupled to a repository (e.g., repository 205, discussed below in relation to FIG. 2) for storing the purchase orders, users' profiles and personal preferences, and/or for hosting the websites that facilitates e-commerce transactions. The repository can include, for example, one or more hard drives (which may be further coupled together using RAID-0, 1, 5, 10, etc.), a centralized or distributed data cluster, a cloud-storage service provider, or other suitable storage systems suitable for storing digital data. Furthermore, although the server 130 is illustrated in FIG. 1 (as well as described throughout the present disclosure) as a separate entity from the client 110, it is noted that in some specific embodiments, both the client 110 and the server 130 can be implemented in the same computing device such as a smart phone or a tablet computer so that the standalone computing device can be the sole host of the environment 100 and practice the various techniques disclosed herein.

The client 110, which may be used by a customer user to communicate with the server 130 in performing the purchases (e.g., through the hosted websites), may include a laptop, a desktop, a tablet, a personal computer, a personal digital assistant (“FDA”), a smart phone, and the like. The client 110 typically includes a display that can be used to display a user interface 115, and may include suitable input devices (not shown for simplicity) such as a keyboard, a mouse, or a touchpad. In some embodiments, the display may be a touch-sensitive screen that includes input functionalities.

FIG. 2 illustrates an abstract functional block diagram of a server 200 further explaining certain components (or modules) and functionalities thereof in the server 100 of FIG. 1 in accordance with some embodiments. The server 200, which is an embodiment of the server 100 of FIG. 1, can include a repository 205, a network interface 210, and an electronic commerce (e-commerce) platform 220. One or more embodiments of the e-commerce platform 220 can include a fashion look engine 230, a user selection receiver 240, and a display output generator 250. In implementing the techniques disclosed herein, the fashion look engine 230 can include, for example, an item/look correlation module 232, a user profile module 234, and a customer look sharing module 236. In some embodiments, the user profile module 234 can comprise a questionnaire module 234a and a purchase history module 234b.

The repository 205 functions similarly to the repository discussed with respect to FIG. 1. The repository 205 can be used for storing the purchase orders, users' profiles and personal preferences, and/or for hosting the websites that facilitates e-commerce transactions. The repository can include, for example, one or more hard drives, a centralized or distributed data cluster, a cloud-storage service provider, or other suitable storage systems suitable for storing digital data.

The user selection receiver module 240 can detect or receive a user's selection from a user's device (e.g., device 110, FIG. 1) (e.g., via an input device coupled to the device 110 such as a mouse, a keyboard, a touchscreen, an actuatable button, a gesture capturing device, a microphone, or the like). The module 240 is coupled to the fashion look engine 220 in communicating the user's selection.

The display output generator module 250 can generate, adjust, modify, replace, or edit the content of web user interface (e.g., interface 115 as displayed on the user's device 110) of the e-commerce platform 220. For example, the display output generator module 250 can include program codes that generate or adjust data using HyperText Markup Language (HTML), Extensible Markup Language (XML), JavaScript Object Notation (JSON), JavaScript and XML (AJAX), and/or other forms and formatting or style information (e.g., Cascading Style Sheets (CSS)) to display or adjust the formatted content (e.g., in forming the e-commerce website user interface 115) on the screen of the device 110.

The network interface 210 can be a networking module that enables the server 110 to mediate data in a network with an entity that is external to the server 110, through any known and/or convenient communications protocol supported by the host and the external entity. The network interface 210 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

The embodiments disclosed herein recognize that aforementioned existing techniques do not adequately address the need of suggesting different looks so as to inspire the customer user when the user shows interests in a product item in order to promote the sales of the entire look and those items included in the looks.

Accordingly, the e-commerce platform 220 includes the capabilities to provide a more natural, convenient and efficient way to promote the sales of entire looks which include multiple completing components, especially when a customer user has expressed interest in one of the items that are in a look. For example, because it is recognized by the present disclosure that, from a fashion standpoint, there are typically certain kind of key pieces of fashion items for a season within a year (e.g., that is high in popularity), the embodiments of e-commerce platform 220 can inspire the customer user different ideas and ways to wear different product items together.

More specifically, in some embodiments, a plurality sets of fashion looks, which can be first preselected by one or more designers, can be stored in the repository 205. Each fashion look can have a different combination of product items that are available for purchase through the e-commerce platform 220. The item/look correlation module 232 can register, edit, or manage the relationships (e.g., through metadata, tags, or other suitable methods) between all the fashion looks stored in the repository 205 and their respective product components which compose the looks.

Then, during normal operations of the server 200, upon receiving a selection of an item from a user (e.g., via the user selection receiver 240), the e-commerce platform 220 can employ the fashion look engine 230 to display (e.g., via the display output generator 250 to the user's computer) the plurality sets of fashion looks, among all of which the selected product item is common. In this way, the e-commerce platform 220 can show the user all the looks that the merchant has styled so as to inspire the user for completing the fashion look.

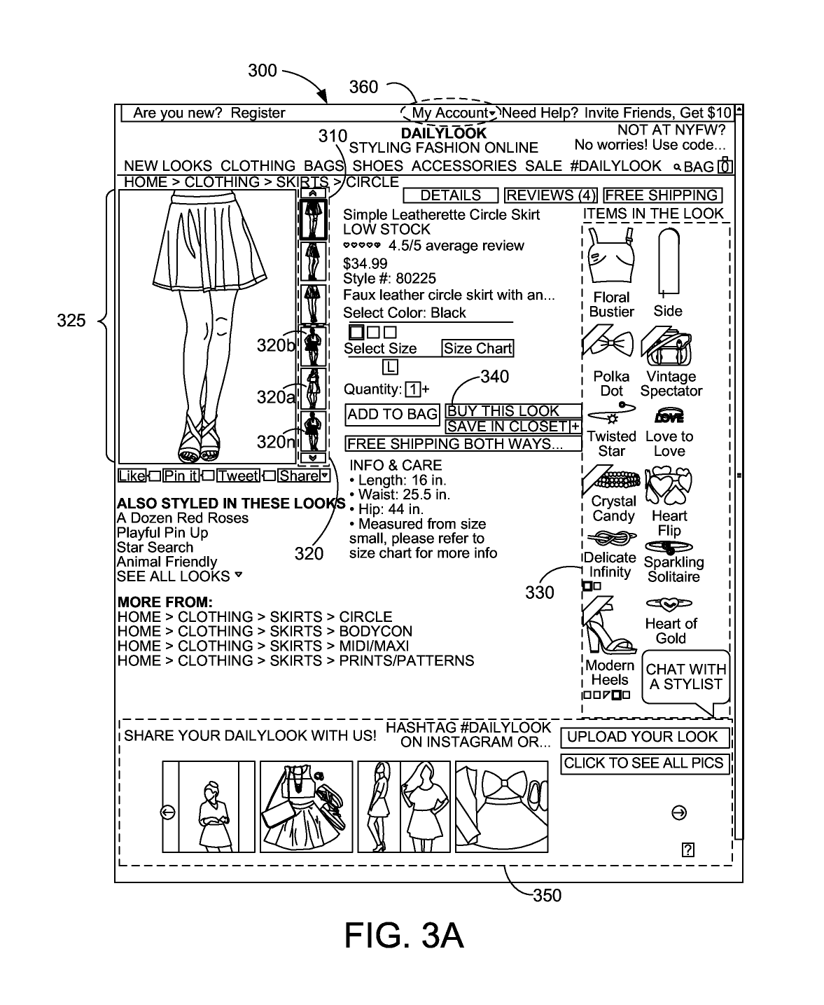

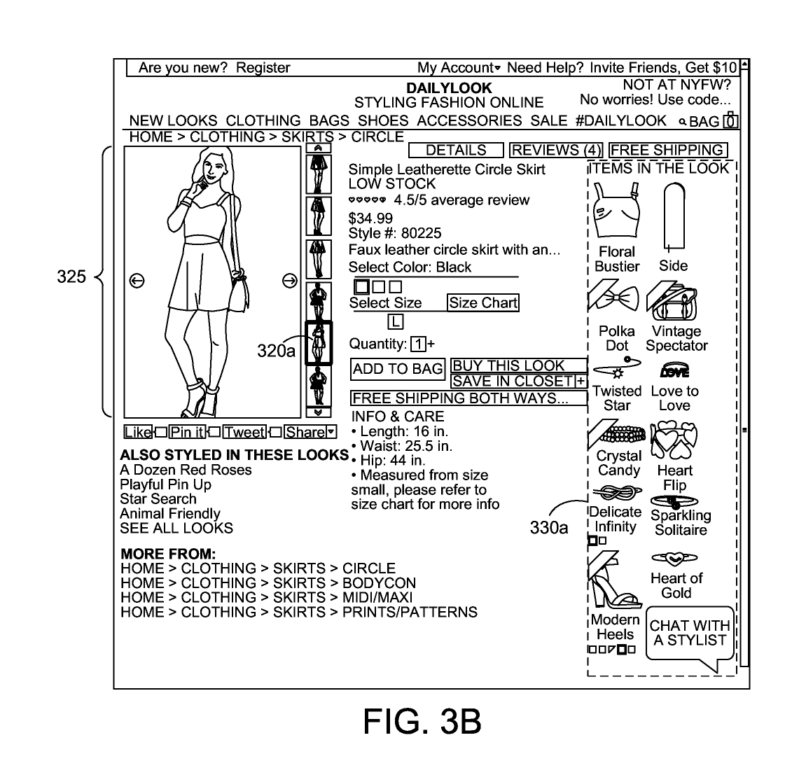

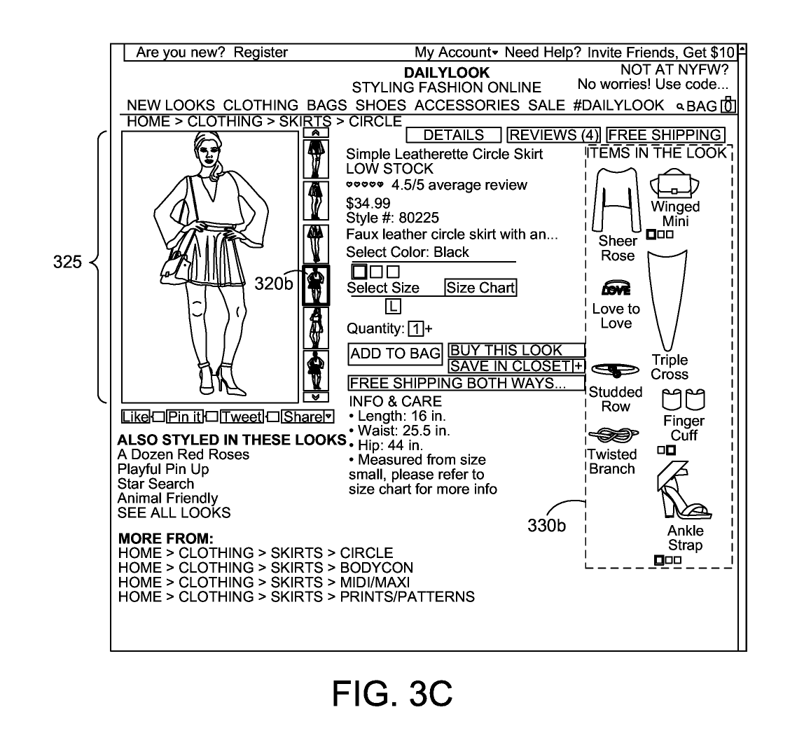

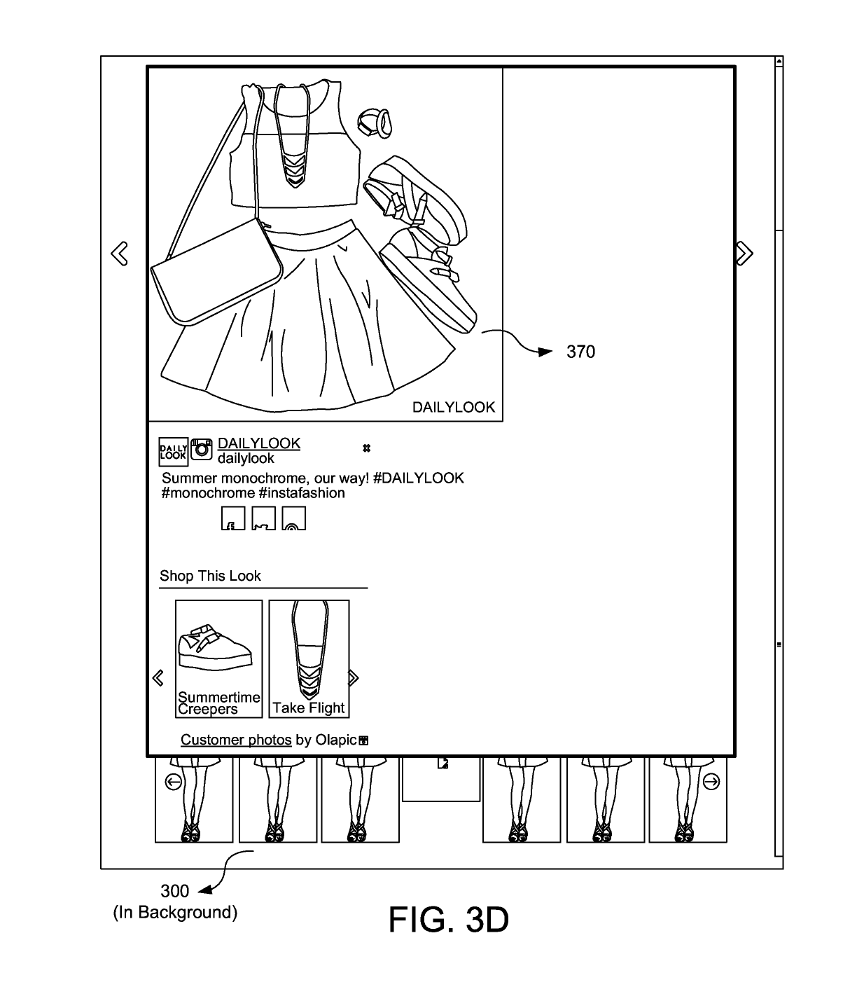

FIGS. 3A-3D respectively illustrate a user interface 300 which can be generated by the server 200 for facilitating online commercial transactions of fashion looks in accordance with some embodiments. The techniques disclosed herein are explained in further detail below with additional reference to FIGS. 1 and 2.

Continuing with the above examples, the item/look correlation module 232 enables the fashion look engine 230 to display a second look in addition to a first look upon receiving a selection of an item from a user. The first and second looks respectively include the selected item in common, and each look has its corresponding set of component products. More specifically, as shown in FIG. 3A, the user interface 300 includes a section 310 which shows a plurality of perspectives (e.g., from different view angles) (when available) of the user selected item.

The interface 300 further includes a main display section 325 which shows a blown-up (or magnified) version of the selected item. Upon the user selecting different perspectives (e.g., via clicking on different perspectives in section 310 as received by the user selection receiver 240), different blown-up pictures corresponding to the selected perspective can be displayed (e.g., by using the display output generator 250) in the main display section 325. A predetermined (e.g., default) view of the selected item may be rendered onto the main display section 215 of the interface 300 when the customer first enters the item page.

According to some embodiments, the interface 300 further includes a “look” section 320 which shows a plurality of curated, fashion looks 320a-320n. As previously mentioned, looks 320a-320n are looks determined or discovered, by the item/look correlation module 232 (e.g., by looking up the repository 205), that the looks 320a-320n include the displayed item as a common item. In some embodiments, the look section 320 can include well-known scrolling mechanisms to enable the user to browse through all the looks 320a-320n without overly expanding the size of the look section 320 so as to hinder the presentation of the displayed item.

Moreover, the interface 300 further includes an “items in the look” section 330 which displays a corresponding set of components in response to which look the user selects. Specifically, to make it intuitive and easy for the user to buy all items in a look (e.g., among looks 320a-320n) that is designed by the merchant, when the user selection receiver 240 receives what look user selects, the item/look correlation module 232 determines what component items are included in the selected look, and the fashion look engine 230 employs the display output generator 250 to display those items in section 330. In one or more embodiments, a predetermined (or default) set of components of a look (e.g., look 320a) may be rendered onto the section 330 for the customer when a look has yet to be selected (e.g., when the customer first enters the product item page).

In some embodiments, the displayed set of components (e.g., for look 320a) are replaced with another corresponding set of components (e.g., for look 320b) when the user selects another look. This technique is illustrated in FIGS. 3B and 3C. In FIG. 3B, the user selects look 320a, and therefore the main display section 325 displays a blown-up version of the look 320a and all the corresponding components 330a, which are included in the look 320a, are displayed in section 330. In FIG. 3C, when the user selects look 320b, the main display section 325 becomes displaying a blown-up version of the look 320b (replacing look 320a), and all the corresponding components 330b which are included in the look 320b are displayed in section 330, replacing components 330a. It is noted that, in some embodiments, the set of corresponding components and the looks can be displayed on the same page (e.g., as shown by FIGS. 3A-3C).

As an optional embodiment, upon the user selects a color for the item being viewed, the look section 320 can selectively display only those looks which correspond to or are otherwise associated with the selected color.

As an addition or an alternative embodiment, the fashion look engine 230 can further provide the capabilities to enable the customer user to purchase each individual product in the fashion look that the customer desires without leave his or her currently browsing page. In particular, a “buy this look” button 340 can be provided to the user (e.g., via interface 300), and when the user selection receiver 240 receives an instruction (e.g., a click on the mouse) from the user to purchase the selected look, the user profile module 234 of the fashion look engine 230 can automatically determine sizing information for each one of components that are included in the selected look based on a profile of the user. For example, the automatic determining can be performed without prompting the user to select which component in the selected look for purchase (e.g., so that the user does not have to choose sizes therefor, either).

More specifically, the customer user can be an existing customer or a new customer. In some embodiments, if the user is an existing customer (e.g., having registered an account with the merchant), information regarding the existing customer's previous purchases as well as other information (e.g., age, occupation, gender, geographic location, etc.) can be stored as a profile of the existing customer in the repository 205. Then, the user profile module 234 can establish a profile of the user by examining a prior purchase history of the existing user. Specifically, the user profile module 234 can employ the purchase history module 234b to perform data mining and analysis (e.g., using data mining techniques known in the art) on the existing customer's purchase history to determine approximate physical measurements of the existing customers. Thereafter, if the existing customer (e.g., after logging into his or her account) selects the button 340) selects to “buy this look” (e.g., by activating the button 340), the user profile module 234 can based on the results of prior data mining and analyses to automatically select or determine sizing information for each one of the components. Some embodiments of the user profile module 234 can further take into consideration the individual properties or characteristics of each component that is included in the targeted look so that module 234 can improve the accuracy of the automatic sizing determination.

Additionally or alternatively, the user profile module 234 can establish or refine the profile of the user by prompting the user with a sizing questionnaire. Specifically, the user profile module 234 can employ the questionnaire module 234a to generate sizing questions to the customer user to establish (e.g., for a new customer) or further refine (e.g., for an existing customer) the estimated physical measurements of the customer. In some implementations, if the customer is a new customer (e.g., having not registered an account), then the questionnaire module 234a can generate an abbreviated version of the questionnaire to the extent that it is pertinent to the instant purchase. For example, if the selected look only includes a skirt instead of a pair of trousers, then the questionnaire module 234a may skip sizing questions that are specific for trousers. In some embodiments, the full-version of the questionnaire can be accessed in a user account's management page (e.g., which can be accessed via a “my account” button 360). Also, in some embodiments, the customer user may choose to enable (e.g., opt-in) or disable (e.g., opt-out) this automatic sizing determination function, or even delete his or her estimated sizing information, for privacy or other suitable reasons. In some embodiments, a new customer can opt-out this automatic sizing determination function when he or she registers an account.

It is noted that, in certain embodiments, the automatic sizing determination only needs to be performed to the extent that it is necessary; for example, a necklace typically does not need sizing information while a jacket typically needs one.

Furthermore, the interface 300 includes a “share your look” section 350, and the fashion look engine 230 can employ the customer look sharing module 236 to enable a customer user to share his or her own assembled looks (e.g., via uploading to the server 200 and stored in repository 205) so that another customer user can also see the shared look(s) when the shared look includes the item being viewed. An example of shared look view page including a shared look 370 provided by a customer user is shown in FIG. 3D. Item pages for the components that are included in the shared look 370 can be entered from a “shop this look” section (e.g., as shown at the bottom of the screenshot of FIG. 3D). Relevant information regarding the shared look and the correlated component items can be provided (e.g., via metadata or tags) by the sharing customer through the customer look sharing module 236 to be stored in repository 205 and managed by the item/look correlation module 232. Additional commenting, voting, ranking, look sharing, adding into favorite, following one or more particular sharing customer users, or other social functions can be included in some additional or alternative embodiments of the customer look sharing module 236 to entice customer users to design and share their looks. These techniques can further create website traffic by creating a sense of community participation among the customer users, which can in turn promote sales of other product items on the e-commerce platform 220.

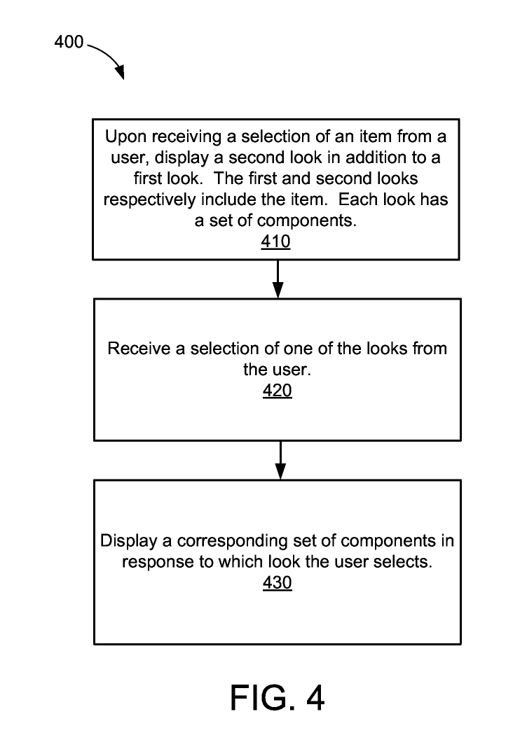

FIG. 4 illustrates a method 400 for promoting sales of fashion looks and items associated therewith in accordance with some embodiments. The method 400 may be performed, for example, in the network environment 100 by the server 130 (FIG. 1) or the server 200 (FIG. 2).

The server 130, 200 can, upon receiving a selection of an item from a user (e.g., via the user selection receiver 240), the server 130, 200 can display (410) (e.g., via the display output generator 250 to the user's computer) a second look in addition to a first look. The first and second looks respectively include (410) the selected product item that is common. Each look has (410) a set of corresponding components. In this way, the server 130, 200 can show the user all the looks that the merchant has styled so as to inspire the user for completing the fashion look.

Next, when server 130, 200 receives (420) a selection of an item from a user, the server 130, 200 displays (430) on the user interface 115, 300 (FIG. 3) a corresponding set of components in response to which look the user selects. In one or more embodiments, a predetermined (or default) set of components of a look (e.g., look 320a) may be rendered onto the user interface 115, 300 for the customer when no look has yet been selected (e.g., when the customer first enters the product item page).

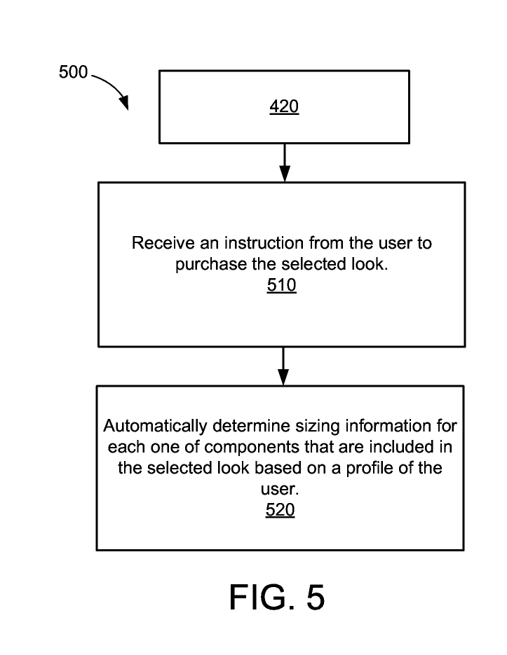

FIG. 5 illustrates additional details that can be implemented with the method of FIG. 4 in accordance with some embodiments.

As an addition or an alternative embodiment, after step 420 of FIG. 4, the server 130, 200 can further provide the capabilities to enable the customer user to purchase each individual product in the fashion look that the customer desires without leave his or her currently browsing page.

In some embodiments, a “buy this look” button 340 can be provided to the user (e.g., via interface 115, 300), and when server 130, 200 receives (510) an instruction (e.g., a click on the mouse) from the user to purchase the selected look, the server 130, 200 can automatically determine (520) sizing information for each one of components that are included in the selected look based on a profile of the user. For example, the automatic determining can be performed without prompting the user to select which component in the selected look for purchase (e.g., so that the user does not have to choose sizes therefor, either).

In this way, among other benefits, the embodiments disclosed herein provide a way that is more natural and convenient to customer users in the effort of promoting fashion looks and the associated items included in a respective look, thereby facilitating a better user experience, inspiring customers' imagination, and stimulating more sales.

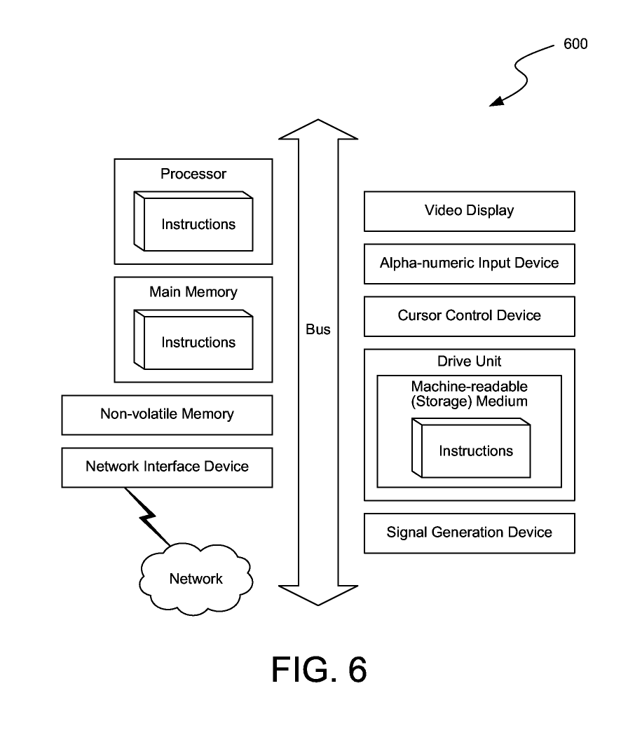

FIG. 6 shows a diagrammatic representation 600 of a machine in the example form of a computer system within which a set of instructions, for causing the machine to perform any one or more of the methodologies discussed herein, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a mobile electronic user device, a tablet PC, a laptop computer, a set-top box (STB), a personal digital assistant (PDA), a cellular telephone or a smart phone (e.g., an iPhone or an Android phone), a web-enabled household appliance, a network router, switch or bridge, a (hand-held) gaming device, a music player, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that can be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system can vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects can likewise be embodied as a means-plus-function claim, or in other forms, such as being embodied in a computer-readable medium. (Any claim intended to be treated under 35 U.S.C. §112, ¶6 begins with the words “means for”.) Accordingly, the applicant reserves the right to add additional claims after filing the application to pursue such additional claim forms for other aspects of the disclosure.

1. A method for facilitating web-based electronic commercial transactions, the method being performed by a server in communication with one or more clients and comprising:
displaying, by the server transmitting via a network to a computer of a user, a user interface on the user's computer;
upon receiving, from the user's computer, a selection of an item from the user, simultaneously displaying a second look in the user interface in addition to displaying a first look in the same user interface, the first and second looks each having a different set of components but both sets of components including the item that is selected by the user;
receiving, from the user's computer, a selection of a one look from the looks displayed in the user interface; and
displaying, in the same user interface where the first and the second looks are displayed, a one corresponding set of components in response to the one look selected by the user.

2. The method of claim 1, wherein the one displayed set of components are replaced with another corresponding set of components when the user selects another look.

3. The method of claim 1, further comprising:
receiving an instruction from the user to purchase the selected look; and
automatically determining sizing attributes for each one of components that are included in the selected look based on a profile that details body size information of the user.

4. The method of claim 3, wherein the automatic determining is performed without prompting the user to select a component in the selected look for purchase.

5. The method of claim 1, further comprising:
establishing a profile that details body size information of the user by examining a prior purchase history of the user.

6. The method of claim 1, further comprising:
establishing a profile that details body size information of the user by prompting the user with a sizing questionnaire.

7. The method of claim 1, further comprising:
displaying a third look which includes the item, wherein the third look is received from another user.

8. The method of claim 1, wherein the corresponding set of components are displayed on a graphic user interface using asynchronous JavaScript™ and Extensible Markup Language (AJAX) code.

9. The method of claim 1, wherein a look and its set of corresponding components are displayed on the same page in the user interface.

10. A method for facilitating electronic commercial transactions, the method comprising:
receiving a selection of a first look from a user;
while displaying the first look which includes an item, displaying a second look which includes the item, wherein the first and second looks each having a set of components;
receiving a selection of one of the looks; and
displaying a corresponding set of components in response to which look the user selects.

11. The method of claim 10, wherein the set of corresponding components and the looks are displayed on the same page, and wherein the displayed set of components are replaced with another corresponding set of components when the user selects another look.

12. The method of claim 10, further comprising:
receiving an instruction from the user to purchase the selected look; and
automatically determining sizing information for each one of components that are included in the selected look based on a profile of the user.

13. The method of claim 12, wherein the automatic determining is performed without prompting the user to select which component in the selected look for purchase.

14. The method of claim 10, further comprising:
establishing a profile that details body size information of the user by examining a prior purchase history of the user.

15. The method of claim 10, further comprising:
establishing a profile that details body size information of the user by prompting the user with a sizing questionnaire.

16. A server system for facilitating web-based electronic commercial transactions with one or more clients that are communicatively coupled to the server system, the system comprising:
a processor; and
a memory coupled to the processor and storing a plurality of instructions which, when executed by the processor, configure the processor to:
transmit, via a network to a computer of a user, a user interface on the user's computer for displaying;
upon receiving, from the user's computer, a selection of an item from the user, simultaneously display a second look in the user interface in addition to displaying a first look in the same user interface, the first and second each having a different set of components but both sets of components including the item that is selected by the user;
receive, from the user's computer, a selection of a one look from the looks displayed in the user interface; and
display, in the same user interface where the first and the second looks are displayed, a one corresponding set of components in response to the one look selected by the user.

17. The system of claim 16, wherein the one displayed set of components are replaced by the processor with another corresponding set of components when the user selects another look.

18. The system of claim 16, wherein the processor is further configured to:
receive an instruction from the user to purchase the selected look; and
automatically determine sizing attributes for each one of components that are included in the selected look based on a profile that details body size information of the user.

19. The system of claim 16, wherein the automatic determining is performed without the processor prompting the user to select a component in the selected look for purchase.

20. The system of claim 16, wherein the processor is further configured to:
establish a profile that details body size information of the user by performing at least one or more of:
(1) examining a prior purchase history of the user; or
(2) prompting the user with a sizing questionnaire.

21. (canceled)
